(19) United States
(12) Patent Application Publication
(10) Pub. No.: US 2026/0318822 A1
(43) Pub. Date: Oct. 15, 2026

(54) EVANESCENT WAVE-BASED NEAR-WALL FLOW PROPERTIES MEASUREMENT DEVICES AND USES THEREOF

(71) Applicant: The Florida State University Research Foundation, Inc., Tallahassee, FL (US)

(72) Inventors: Huixuan Wu, Tallahassee, FL (US); Mohammadmobin Bakhshisiahkolaei, Tallahassee, FL (US); Jonas Gustavsson, Tallahassee, FL (US)

(21) Appl. No.: 19/643,226

(22) Filed: Apr. 9, 2026

Related U.S. Application Data
(60) Provisional application No. 63/785,900, filed on Apr. 9, 2025.

(51) Int. Cl. G01N 21/21; G01N 21/01; G01N 21/85

(52) U.S. Cl. CPC G01N 21/211; G01N 21/01; G01N 21/85; G01N 2021/0125; G01N 2021/0137; G01N 2021/212; G01N 2021/8578

(57) ABSTRACT

Disclosed herein are systems and methods for non-invasively characterizing near-wall properties of a compressible fluid. The systems and methods can measure near-wall fluid properties for complex flow patterns based on changes in polarization composition following total internal reflection (TIR) of an incident light signal. The systems and methods described herein can be used to visualize/characterize two-dimension (2D) and three-dimensional (3D) shock-boundary-layer interactions (SBLIs) in complex flow patterns.

### CROSS-REFERENCE TO RELATED APPLICATION

This Application claims priority to and benefit under 35 U.S.C. § 119(e) of U.S. Provisional Patent Application Ser. No. 63/785,900, entitled “EVANESCENT WAVE-BASED NEAR-WALL FLOW PROPERTIES MEASUREMENT DEVICES AND USES THEREOF,” filed Apr. 9, 2025, which is hereby incorporated by reference herein in its entirety.

### STATEMENT OF GOVERNMENT INTEREST

This invention was made with government support under W911NF-25-1-0139 awarded by the Army Research Office. The government has certain rights in the invention.

### BACKGROUND

Current understanding shows that 3D Shock-boundary-layer interactions (SBLIs) differ fundamentally from their 2D counterparts in both structure and dynamics. In 2D SBLIs, the flow typically features a closed separation bubble with reversed flow, well-defined separation and reattachment points, and dominant low frequency “breathing” oscillations that scale with the separation length. In contrast, 3D interactions exhibit open, highly skewed separation, and their unsteadiness shifts toward higher, mid-frequency ranges-likely associated with shear-layer dynamics rather than global oscillations.

Most experimental and computational studies to date have focused on canonical, shock-dominated configurations, including sharp fins, swept compression ramps, double fins, and blunt-fin. These geometries provide controlled environments for studying the effects of shock-induced separation and represent increasing degrees of three-dimensionality relevant to inlets, control surfaces, and high-speed vehicle components. However, such canonical configurations remain idealized and cannot fully capture the complexity of realistic flow environments.

For instance, in a compressor passage, the geometry and flow environment differ fundamentally from those in existing 3D SBLI studies. In these systems, the shock wave interacts not only with the boundary layer but also with other large-scale flow structures, such as tip-leakage vortices or passage vortices, that form independently of the shock. These coupled interactions lack a single dominant geometric or dynamic scale, involve strong crossflow and anisotropic turbulence, and exhibit local symmetry breakdowns. As a result, conventional scaling laws and modeling approaches developed for canonical SBLIs are not directly applicable.

Major diagnostic techniques for measuring density, pressure, and temperature in compressible flows include Schlieren imaging, Rayleigh scattering, pressure- and temperature-sensitive paints (PSP and TSP), planar laser-induced fluorescence (PLIF), laser differential interferometry, and coherent anti-Stokes Raman scattering (CARS), among others. Each method offers unique advantages and faces various limitations.

Schlieren imaging is a classical technique that visualizes flow density gradients, but its quantitative accuracy is limited because the recorded signal represents the line-integrated density gradient along the entire optical path. Moiré deflectometry, an extension of Schlieren methods, can retrieve temperature and density gradients, yet its spatial resolution remains constrained. Rayleigh scattering enables temperature, velocity, and density measurements in unseeded turbulent flows; however, strong background scattering, especially from wall reflections, introduces large uncertainties, making it unsuitable for boundary-layer applications.

For near-wall measurements, PSP and TSP are among the most advanced techniques available. While they provide valuable surface pressure and temperature information, their performance strongly depends on material properties, limiting applicability in high-temperature or reacting environments. Similarly, PLIF and other molecular-tagging approaches can measure velocity and temperature in high-speed flows but require specific tracer species (e.g., nitric oxide, NO), which are impractical or unsafe for in situ flight testing. Consequently, there is a critical need for a non-intrusive diagnostic method that can operate across diverse flow conditions without relying on specialized materials or tracers.

Flow density variations also modify the local refractive index, inducing optical phase shifts that can be detected through interferometric techniques. For example, laser interferometers such as LIGO can resolve phase changes as small as 10⁻¹⁰ radians. The laser differential interferometer can measure density differences between two nearby points, but it is difficult to extend this method to multi-point or field measurements. Similarly, CARS provides high accuracy but is limited to single-point measurements and cannot readily capture two-dimensional flow fields. Moreover, most of these optical methods are optimized for wind-tunnel setups, where illumination and detection systems are located on opposite sides of the test section. In practical applications such as flight testing, it is challenging to illuminate and image regions of interest-such as the outer surface of a missile or the internal wall of an engine-making real-time, in situ measurements nearly impossible with existing technology.

Thus, there is a need for systems and methods to study and characterize boundary-layer interactions, particularly 3D boundary-layer interactions, in complex internal flows.

### SUMMARY

The systems and methods described herein address these and other issues. For example, the systems and methods of the present disclosure provide a surface density measurement technique based on evanescent-wave optics and single-photon quantum sensing. The systems and methods can be used to study and/or control the influence of shock curvature and unsteadiness on 3D SBLIs in complex, high-speed flow environments.

Various aspects include a method for (e.g., non-invasively) characterizing near-wall properties of a compressible fluid.

In some aspects, the method includes: irradiating an internal reflection element (IRE) with a linearly polarized incident light signal (e.g., a laser beam), wherein the IRE is positioned relative to a wall to form a refractive boundary together with a fluid (e.g., flowing at high speeds) along the wall, wherein the linearly polarized incident light signal undergoes total internal reflection (TIR) within the IRE at the refractive boundary to form a reflected light signal; splitting the reflected light signal using an optical polarizer (e.g., a Wollaston prism) to form a first polarized component and a second polarized component of the reflected light signal, wherein the first polarized component and the second polarized component have different (e.g., orthogonal) polarizations, detecting via a balanced photodetector the first and/or second polarized components of the reflected light signal; and determining one or more fluid characteristics (e.g., fluid density and/or temperature) from the first and/or second polarized components of the reflected light signal (e.g., based on a relative change in intensity of the first and/or second polarized components of the reflected light signal compared to a baseline value).

In some aspects, the one or more fluid characteristic comprises fluid density.

In some aspects, the method further includes: outputting a report (e.g., via a graphical user interface) comprising qualitative/quantitative information about the one or more fluid characteristics.

In some aspects, the report comprises a two-dimensional map depicting a spatial representation (e.g., a 2D density distribution) of the one or more fluid characteristics (e.g., fluid density) over an 2D area of the wall.

In some aspects, the one or more fluid characteristics is determined in real-time.

In some aspects, the method further includes: adjusting a system parameter (e.g., flow rate, pressure, temperature, amount/ratio of reaction component(s), orientation of mechanical component(s), etc.) based on the determined one or more fluid characteristics.

In some aspects, the fluid is a gas.

In some aspects, the fluid is flowing at a transonic or supersonic velocity along the wall.

In some aspects, the linearly polarized incident light signal comprises an array of incident light signals over a 2D area along the wall, and wherein the reflected light signal comprises an array of reflected light signals corresponding to phase shifted signals following TIR of the array of incident light signals.

In some aspects, the wall comprises one or more surface markers, and wherein one or more surface markers are used to index a spatial location of a pixel in the 2D area.

In some aspects, the method further includes interrogating the reflected light signal using an optical fiber fixedly coupled to the IRE.

In some aspects, the one or more fluid characteristics is determined by comparing an intensity of the first and/or second polarization components to a calibration curve.

In another aspects, described herein is a system. In some aspects, the system includes: a sensing component comprising: a light source configured to provide a linearly polarized incident light signal (e.g., a laser beam) to an internal reflection element (IRE), the IRE configured to be positioned relative to a wall to form a refractive boundary with a fluid (e.g., flowing at high speeds) along the wall such that a reflected light signal is formed when the linearly polarized incident light signal undergoes total internal reflection (TIR) within the IRE at the refractive boundary, an optical polarizer, wherein the optical polarizer is configured to split the reflected light signal to form a first polarized component and a second polarized component of the reflected light signal, wherein the first polarized component and the second polarized component have different (e.g., orthogonal) polarizations, and a photodetector (e.g., a balanced photodetector) positioned to detect the first and/or second polarized components of the reflected light signal; and a processor, and memory operatively coupled to the processor and having instructions stored thereon, wherein execution of the instructions by the processor causes the processor (e.g., in real-time) to: obtain data from the photodetector corresponding to an intensity of the first and/or second polarized components of the reflected light signal, and determine one or more fluid characteristics (e.g., fluid density and/or temperature) from the data (e.g., based on a relative change in intensity of the first and/or second polarized components of the reflected light signal compared to a baseline value).

In some aspects, the light source is configured to provide an array of incident light signals over a 2D area.

In some aspects, the processor is further configured to generate a report (e.g., via a graphical user interface) comprising qualitative/quantitative information about the one or more fluid characteristics.

In some aspects, the report comprises a two-dimensional map depicting a spatial representation (e.g., a 2D density distribution) of the one or more fluid characteristics (e.g., fluid density) over an area of the wall.

In some aspects, the processor is further configured to adjust a process parameter (e.g., flow rate, pressure, temperature, amount/ratio of reaction component(s), orientation of mechanical component(s), etc.) based on the determined one or more fluid characteristics.

In some aspects, the photodetector comprises a single-photon detector (e.g., a single-photon avalanche diode).

In some aspects, the system further includes an optical fiber bundle fixedly or detachably coupled to the IRE to interrogate the reflected light signal and to transmit the reflected light signal to the optical polarizer and/or the photodetector.

In some aspects, the processor is further configured to determine the one or more fluid characteristics by comparing an intensity of the first and/or second polarization components to a calibration curve.

Certain advantages of the disclosed subject matter will be set forth in part in the description that follows and the Figures, and in part will be obvious from the description, or can be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

The skilled person in the art will understand that the drawings, described below, are for illustration purposes only.

FIG. 1 shows an exemplary system for non-invasively characterizing near-wall properties of a compressible fluid according to one illustrative aspect.

FIG. 2 shows the complex interactions of shock wave, vortical structures, and boundary layer in a complex environment like a compressor passage. The vortical structures exist independent of the shock waves.

FIG. 3 shows a schematic depicting polarization changes of evanescent wave-based density detector.

FIG. 4 shows (Panel a) a schematic depicting single point EWDD measurements, (Panel b) an image showing the experimental setup, and (Panel c) the test chamber.

FIG. 5 shows a plot illustrating readings of balanced photodetector as the species of gas in the chamber was changed. Gas: 0-1 min CO₂; 1-2.5 min, He; and 2.5-4.5 min N₂.

FIG. 6 shows a sketch of the two-dimensional (2D) EWDD setup. The incident laser has a uniform polarization. After total internal reflection, the laser polarization becomes non-uniform due to the variation of wall surface fluid density distribution. The reflection beam passes a polarized beam splitter (which can be a Wollaston prism). The |h [symbol] component is recorded using a SPAD camera (single photon quantum sensing camera).

FIG. 7 a high-pressure chamber design for steady and quasi steady calibration. The pressure gauge, thermometer, and laser in the EWDD system are omitted for clarity.

FIG. 8 shows a schematic of the 2D SBLI experimental setup. Inlet Mach number M=1.1-1.5. For clarity, the laser and optics of the 2D EWDD system is shown as a sketch or omitted.

FIG. 9 illustrates a setup to study shock, tip leakage vortex, and boundary layer interaction that mimic the complex environment in a compressor.

### DETAILED DESCRIPTION

The materials, compounds, compositions, articles, and methods described herein may be understood more readily by reference to the following detailed description of specific aspects of the disclosed subject matter and the Examples and Figures included therein.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### General Definitions

In this specification and in the claims that follow, reference will be made to a number of terms, which shall be defined to have the following meanings:

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “the compound” includes mixtures of two or more such compounds, reference to “an agent” includes mixture of two or more such agents, and the like.

“Optional” or “optionally” means that the subsequently described event or circumstance can or cannot occur, and that the description includes instances where the event or circumstance occurs and instances where it does not.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g. 1 to 5 includes 1, 1.5, 2, 2.75, 3, 3.90, 4, 4.24, and 5). Similarly, numerical ranges recited herein by endpoints include subranges subsumed within that range (e.g. 1 to 5 includes 1-1.5, 1.5-2, 2-2.75, 2.75-3, 3-3.90, 3.90-4, 4-4.24, 4.24-5, 2-5, 3-5, I-4, and 2-4). It is also to be understood that all numbers and fractions thereof are presumed to be modified by the term “about.” It must also be noted that, as used in the specification and the appended claims, the singular forms “a,” “an” and “the” include plural referents unless the context clearly dictates otherwise. Ranges may be expressed herein as from “about” or “approximately” one particular value and/or to “about” or “approximately” another particular value. When such a range is expressed, other exemplary embodiments include from the one particular value and/or to the other particular value.

It should be appreciated that any element, part, section, subsection, or component described with reference to any specific embodiment above may be incorporated with, integrated into, or otherwise adapted for use with any other embodiment described herein unless specifically noted otherwise or if it should render the embodiment device non-functional. Likewise, any step described with reference to a particular method or process may be integrated, incorporated, or otherwise combined with other methods or processes described herein unless specifically stated otherwise or if it should render the embodiment method nonfunctional. Furthermore, multiple embodiment devices or embodiment methods may be combined, incorporated, or otherwise integrated into one another to construct or develop further embodiments of the invention described herein.

It should be appreciated that the device and related components discussed herein may take on all shapes along the entire continual geometric spectrum of manipulation of x, y and z planes to provide and meet the environmental, and structural demands and operational requirements. Moreover, locations and alignments of the various components may vary as desired or required consistent with this disclosure. It should be appreciated that various sizes, dimensions, contours, rigidity, shapes, flexibility and materials of any of the components or portions of components in the various embodiments discussed throughout may be varied and utilized as desired or required. It should be appreciated that while some dimensions are provided on the aforementioned figures, the device may constitute various sizes, dimensions, contours, rigidity, shapes, flexibility and materials as it pertains to the components or portions of components of the device, and therefore may be varied and utilized as desired or required.

Additional descriptions of aspects of the present disclosure will now be provided with reference to the accompanying drawings. The drawings form a part hereof and show, by way of illustration, specific embodiments or examples.

### System

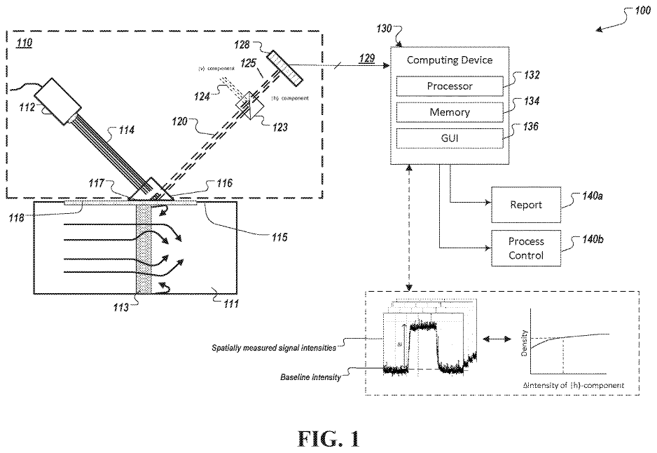

FIG. 1 shows an exemplary system 100 characterizing and controlling near-wall properties of a compressible fluid. The system 100 includes: a sensing component 110 and a computing device 130. The sensing component 110 is configured with a light source 112 which can generate a linearly polarized incident light signal 114 to an internal reflection element (IRE) 116. As used herein, the term “internal reflection element” or IRE refers to a crystal, prism, or other structure that will admit incoming radiation from a light source and reflect the radiation at least once from a surface on the interior of the element, preferably following interaction of the radiation with a sample in contact with the reflecting surface. Following such a reflectance, the radiation can be re-reflected or emitted from the element. The material and shape of the IRE may vary depending on several parameters, such as the wavelength and intensity of light and the geometric constrictions. Generally, the IRE is formed from a material with higher index of refraction than the refractive index of the fluid flowing along the wall that is capable of transmitting IR or visible light.

The light source 112 can be any suitable device that can emit light energy. For example, the light source can include a laser, or a laser stack that generate a polarized light at a specific optical frequency. Other suitable light sources include, but are not limited to, hyperspectral/multispectral light sources, white light, partially polarized light sources, and the like. In some aspects, a wavelength of the light signal is from 10 nanometers (nm) to 10000 nm. For example, the wavelength of the light signal can have one or more wavelength corresponding to one or more of ultra-violet (e.g., 10-380 nm); violet (e.g., 380-450 nm), blue (e.g., 450-495 nm), green (e.g., 495-570 nm), yellow (e.g., 570-590 nm), orange (e.g., 590-620 nm), red (e.g., 620-750 nm); or infrared (e.g., 750-10000 nm). In some aspects, a plurality of light signals (e.g., 2, 3, 4, 5, 6, 7, etc.) having different wavelengths can be used to assess/ameliorate noise and other uncertainties. The light source 112 shown in FIG. 1 is configured to provide an array of incident light signals over a 2D area. Each signal of the array of polarized light signals is distributed to provide phase shift or polarization change information at a specific pixel within the 2D area.

Although not shown in FIG. 1, other optical elements, such as mirrors, lens, optical polarizers and/or waveplates may be used to reflect, focus, tune, and/or adjust the light source before reaching the IRE. The terms “optical polarizer” and “polarizer” are used interchangeably and each refer to an element which selectively transmits light with a particular polarization (i.e., light with other polarizations are not transmitted). A specific type of optical polarizer is a “polarizing beam splitter” (PBS) which refers to a polarizer that can substantially transmit one polarization and can substantially reflect an opposite polarization (e.g., having an orthogonal polarization). Likewise, the term “wave-plate” refers to an element which alters the polarization state of light which passes through it, but does not selectively transmit light with a particular polarization.

The IRE 116 shown in FIG. 1 is positioned relative to a wall 115 to form a refractive boundary 117 with a fluid flowing (e.g., at high speeds) along the wall 115. For example, the IRE can be integrally formed with the wall or can separately be placed/attached to for the refractive boundary. In FIG. 1, the sensing component 110 of the system 100 is arranged to optically couple with a transparent window 118 forming a portion of the wall 115. By isolating the sensing component 110 from the fluid path, the system 100 is able to non-invasively characterize properties of the fluid without interference. This arrangement is further agnostic with respect to the identity of the fluid, making it robust for numerous applications. As shown in FIG. 1, the wall 115 defines at least a portion of a boundary for a measurement channel 111 for the fluid flowing therewithin. Within the measurement channel 111, a flow structure 113 is provided to examine the effects of the fluid at the wall 115. The flow structure 113 is generally an element or device that will be exposed to high-speed fluid flow in which boundary interactions are of interest. For example, the flow structure 113 can include a wing, blade, spoiler, or another structure. Although the sensing component 110 shown in FIG. 1 is shown in connection with a wall 115 of chamber/channel, it is also possible to characterize near-wall flow properties of open-ended system where boundary conditions are only significant along one wall. In some aspects, the system is a closed or semi-closed system.

Once the IRE 116 is irradiated with the linearly polarized incident light signal 114, a reflected light signal 120 is formed when the incident light signal 114 undergoes total internal reflection (TIR) within the IRE 116 at the refractive boundary 117. Without wishing to be bound by theory, this phenomena occurs when light traveling within a medium (e.g., the transparent wall) impinges upon an interface between that medium and a medium of lower refractive index (e.g., the fluid), it either passes into the second medium or is totally internally reflected, depending on whether the quantity [n₁/n₂ sin θᵢ] is less than or greater than one. In this relationship, n₁ and n₂ are the refractive indices of the first and second media, respectively, and θᵢ is the angle of incidence. If n₁/n₂ sin θᵢ is greater than one, total internal reflection occurs. Although the internal reflection is referred to as total, the light, during the reflection process, penetrates a short distance into the second medium. The depth of penetration typically depends on the refractive indices of the two media and the angle of incidence and is typically on the order of tenths of the wavelength of the light.

The sensing component 110 of the system 100 further includes an optical polarizer 123. The optical polarizer 123 is configured to split the reflected light signal 120 to form a first polarized component 124 and a second polarized component 125 of the reflected light signal 120. The first polarized component 124 and the second polarized component 125 have orthogonal polarizations. The sensing component 110 further includes a photodetector 128 (e.g., a balanced photodetector) positioned to detect the first and/or second polarized components 124/125 of the reflected light signal 120. In some aspects, the photodetector comprises a single-photon detector (e.g., a single-photon avalanche diode). Although not shown, it may be further advantageous to use an optical fiber bundle fixedly or detachably coupled to the IRE to interrogate the reflected light signal and to transmit the reflected light signal to the optical polarizer and/or the photodetector. By including an optical fiber bundle, it is possible to reduce and/or remove noise caused by mechanical vibrations.

The system 100 further includes a computing device 130. In its most basic configuration, the computing device 130 includes at least one processing unit (shown as processor 132) and system memory 134. Depending on the exact configuration and type of computing device, system memory may be volatile (such as random-access memory (RAM)), non-volatile (such as read-only memory (ROM), flash memory, etc.), or some combination of the two.

The processing unit may be a programmable processor or a graphic processing unit that performs arithmetic and logic operations necessary for the operation of the computing device. While only one processing unit is shown, multiple processors (CPU, GPU, AI chip) may be present. As used herein, processing unit and processor refer to a physical hardware device that executes encoded instructions for performing functions on inputs and creating outputs, including, for example, but not limited to, microprocessors (MCUs), microcontrollers, graphical processing units (GPUs), and application-specific circuits (ASICs). Thus, while instructions may be discussed as executed by a processor, the instructions may be executed simultaneously, serially, or otherwise executed by one or multiple processors. The computing device may also include a bus or other communication mechanism for communicating information among various components of the computing device.

Execution of the instructions on the memory 134 by the processor 132 causes the processor 132 (e.g., in real-time) to: obtain data 129 from the photodetector 128 corresponding to an intensity of the first and/or second polarized components 124/125 of the reflected light signal 120, and determine one or more fluid characteristics (e.g., fluid density and/or temperature) from the data (e.g., based on a relative change in intensity of the first and/or second polarized components of the reflected light signal compared to a baseline value). In the aspect described in FIG. 1, the processor is configured to determine the one or more fluid characteristics by comparing an intensity of the first and/or second polarization components to a calibration curve. The calibration curve can be generated experimentally by measuring changes in signal intensity for known fluid properties (e.g., density). Other methods to correlate the one or more fluid properties and the intensity can also be used, including but not limited to, machine learning algorithms.

The processor shown in FIG. 1 is further configured to generate a report 140a via a graphical user interface (GUI) 136. As used herein, the term “report” refers to a record or summary of the information which may be provided in written, graphical, electronic, or audio form, or combinations of these forms, as described above. The report 140a includes qualitative/quantitative information about the one or more fluid characteristics based on a phase shift and/or a polarization change. For example, in some aspects, the report can include a two-dimensional map depicting a spatial representation (e.g., a 2D density distribution) of the one or more fluid characteristics (e.g., fluid density) over an area of the wall. In some aspects, the report includes a temperature map.

The processor 132 can further be configured to adjust a process parameter (e.g., flow rate, pressure, temperature, amount/ratio of reaction component(s), orientation of mechanical component(s), etc.) via control signals 140b based on the determined one or more fluid characteristics. In some aspects, the one or more fluid characteristics can be provided as an input for a feedback control loop to minimize or reduce undesired conditions. For example, a 2D density map can be determined and used to assess for the formation of shock-boundary-layer interactions (SBLIs). As density fluctuations are observed, upstream adjustments, such as a reduction of flow velocity or pressure can be incorporated to ameliorate these issues.

Computing devices may have additional features/functionality. For example, the computing device may include additional storage such as removable storage and non-removable storage including, but not limited to, magnetic or optical disks or tapes. Computing devices may also contain network connection(s) that allow the device to communicate with other devices, such as over the communication pathways described herein. The network connection(s) may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. Computing devices may also have input device(s) such as keyboards, keypads, switches, dials, mice, trackballs, touch screens, voice recognizers, card readers, paper tape readers, or other well-known input devices. Output device(s) such as printers, video monitors, liquid crystal displays (LCDs), touch screen displays, displays, speakers, etc., may also be included. The additional devices may be connected to the bus in order to facilitate the communication of data among the components of the computing device. All these devices are well-known in the art and need not be discussed at length here.

The computing device may be configured to execute program code encoded in tangible, computer-readable media. Tangible, computer-readable media refers to any media that is capable of providing data that causes the computing device (i.e., a machine) to operate in a particular fashion. Various computer-readable media may be utilized to provide instructions to the processing unit for execution. Example tangible, computer-readable media may include but is not limited to volatile media, non-volatile media, removable media, and non-removable media implemented in any method or technology for storage of information such as computer-readable instructions, data structures, program modules, or other data. System memory, removable storage, and non-removable storage are all examples of tangible computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In light of the above, it should be appreciated that many types of physical transformations take place in the computer architecture to store and execute the software components presented herein. It also should be appreciated that the computer architecture may include other types of computing devices, including hand-held computers, embedded computer systems, personal digital assistants, and other types of computing devices known to those skilled in the art.

In an example implementation, the processing unit may execute program code stored in the system memory. For example, the bus may carry data to the system memory, from which the processing unit receives and executes instructions. The data received by the system memory may optionally be stored on the removable storage or the non-removable storage before or after execution by the processing unit.

The exemplary system and method may be implemented (1) as a sequence of computer-implemented acts or program modules running on a computing system and/or (2) as interconnected machine logic circuits or circuit modules within the computing system. The logical operations described herein are referred to variously as state operations, acts, or modules. These operations, acts, and/or modules can be implemented in software, in firmware, in special-purpose digital logic, in hardware, and any combination thereof. It should also be appreciated that more or fewer operations can be performed than shown in the figures and described herein. These operations can also be performed in a different order than those described herein.

Although the system may operate via a local computing device, other embodiments may utilize a network interface to transmit the signal data obtained from the sensing component to another computing device. As used herein, the term “network interface” refers to any signal, data, and/or software interface with a component, network, and/or process. By way of non-limiting example, a network interface may include one or more of FireWire (e.g., FW400, FW110, and/or other variation.), USB (e.g., USB2), Ethernet (e.g., 10/100, 10/100/1000 (Gigabit Ethernet), 10-Gig-E, and/or other Ethernet implementations), MoCA, Coaxsys (e.g., TVnet™), radio frequency tuner (e.g., in-band or OOB, cable modem, and/or other protocol), Wi-Fi (802.11), WiMAX (802.16), PAN (e.g., 802.15), cellular (e.g., 3G, LTE/LTE-A/TD-LTE, GSM, and/or other cellular technology), IrDA families, and/or other network interfaces. As used herein, the term “Wi-Fi” includes one or more of IEEE-Std. 802.11, variants of IEEE-Std. 802.11, standards related to IEEE-Std. 802.11 (e.g., 802.11 a/b/g/n/s/v), and/or other wireless standards. As used herein, the term “wireless” means any wireless signal, data, communication, and/or other wireless interface. By way of non-limiting example, a wireless interface may include one or more of Wi-Fi, Bluetooth, 3G (3GPP/3GPP2), HSDPA/HSUPA, TDMA, CDMA (e.g., IS-95A, WCDMA, and/or other wireless technology), FHSS, DSSS, GSM, PAN/802.15, WiMAX (802.16), 802.20, narrowband/FDMA, OFDM, PCS/DCS, LTE/LTE-A/TD-LTE, analog cellular, CDPD, satellite systems, millimeter wave or microwave systems, acoustic, infrared (i.e., IrDA), and/or other wireless interfaces.

Cloud System. The computer system is capable of executing the software components described herein for the exemplary method or systems. In an embodiment, the computing device may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computing device to provide the functionality of a number of servers that are not directly bound to the number of computers in the computing device. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or can be hired on an as-needed basis from a third-party provider. Some cloud computing environments may comprise cloud computing resources owned and operated by the enterprise as well as cloud computing resources hired and/or leased from a third-party provider.

In some aspects, part or all of the system is provided as a portable device. For example, a portable device can include the sensing component disposed within a portable housing to facilitate the use of the system at different locations. In this arrangement, the light source together with any other electronic components (e.g., the computing device) can be powered using a power source such as a battery. The IRE of the device can be selectively exposed such that an end/side of the device can be optically coupled to a location of interest. In some aspects, the portable device is configured to transmit signals containing the data (e.g., wirelessly) to a remote or separate computing device. However, in other aspects, the computing device is located within the portable house itself.

### Methods

Disclosed herein is a method for (e.g., non-invasively) characterizing near-wall properties of a compressible fluid. In some aspects, the method includes: irradiating an internal reflection element (IRE) with a linearly polarized incident light signal (e.g., a laser beam). The IRE is positioned relative to a wall to form a refractive boundary together with a fluid flowing (e.g., at high speeds) along the wall. As used herein, the term “fluid” denotes any liquid, gas, liquid-gas mixtures and any mixture of solids in liquid that has fluid attributes. In some aspects, the fluid is a gas or a combination of gases. In some aspects, the fluid is flowing at a transonic or supersonic velocity along the wall.

The linearly polarized incident light signal undergoes total internal reflection (TIR) within the IRE at the refractive boundary to form a reflected light signal. When the incident light signal (or array of incident light signals) undergoes TIR, the linearly polarized signal is converted to an elliptically polarized signal. Changes in the magnitude polarization composition (e.g., the intensity of the light signal in different polarized orientations) of the reflected light signals depends on the physical properties of the fluid.

The method further includes splitting the reflected light signal using an optical polarizer (e.g., a Wollaston prism) to form a first polarized component and a second polarized component of the reflected light signal. The first polarized component and the second polarized component have orthogonal polarizations. The first and/or second polarized components of the reflected light signal are detected from a photodetector (e.g., a balanced photodetector) where they are interpreted and processed by a computing device.

From this, one or more fluid characteristics (e.g., fluid density and/or temperature) are determined from the first and/or second polarized components of the reflected light signal (e.g., based on a relative change in intensity of the first and/or second polarized components of the reflected light signal compared to a baseline value). In some aspects, the one or more fluid characteristic comprises fluid density. Signals may be processed according to any technique known in the art to reduce noise and facilitate the analysis by the computing device.

In some aspects, the method further includes: outputting a report (e.g., via a graphical user interface) comprising qualitative/quantitative information about the one or more fluid characteristics. In some aspects, the report comprises a two-dimensional map depicting a spatial representation (e.g., a 2D density distribution) of the one or more fluid characteristics (e.g., fluid density) over an 2D area of the wall.

In some aspects, the one or more fluid characteristics is determined in real-time. In this regard, the method can further include adjusting a system parameter (e.g., flow rate, pressure, temperature, amount/ratio of reaction component(s), orientation of mechanical component(s), etc.) based on the determined one or more fluid characteristics.

In some aspects, the linearly polarized incident light signal comprises an array of incident light signals over a 2D area along the wall, and wherein the reflected light signal comprises an array of reflected light signals corresponding to phase shifted signals following TIR of the array of incident light signals. To ensure proper localization of the signal for a 2D, the wall can include one or more surface markers to index a spatial location of a pixel in the 2D area. Non-limiting examples of surface markers can include unique geometric arrangements that may be detected by the photodetector or materials having a distinct reflection pattern.

In some aspects, the method further includes interrogating the reflected light signal using an optical fiber fixedly or detachably coupled to the IRE. In some aspects, the one or more fluid characteristics is determined by comparing an intensity of the first and/or second polarization components to a calibration curve.

### EXAMPLES

The following examples are set forth below to illustrate the systems and methods and provides results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

### Example 1: Development of Single-Point Evanescent Wave Density Detector for Compressible Turbulent Flows

To measure near-wall flow properties and overcome the limitations of existing diagnostic techniques, the study describes the development of single point Evanescent Wave Density Detector (EWDD) technique. As illustrated in FIG. 3, a laser beam is directed onto a wall surface through a prism. When the incidence angle exceeds the critical value, total internal reflection (TIR) occurs, and an evanescent wave is generated immediately beyond the solid surface. From a quantum perspective, the reflection process transforms a linearly polarized photon |v [symbol] into a superposition state according to:

U_{TIR}|v [symbol] →α|v [symbol] +β|h [symbol]
where U_{TIR} represents the reflection operator, and the |v [symbol] and |h [symbol] polarization directions are defined in FIG. 3. The probability of detecting an h-polarized photon depends on the local fluid density near the wall, |β|² f(ρ). Therefore, by measuring the polarization composition of the reflected beam, the EWDD provides a direct and sensitive measure of fluid density immediately adjacent to the surface.

Using classic physics language, total internal reflection can convert a linearly polarized laser to an elliptically polarized beam. Thus, analyzing the polarization can result in the density. Specifically, the gas refractive index follows the Gladstone-Dale relation n_{gas}=1+Kρ where K is a constant (K=2.2×10⁻⁴ for air). Assume the refractive index of the wall is n_{wall}. The reflection induces a phase delay between the ∥ and L components.

$$δ = {δ}_{\vert \vert} - {δ}_{⊥} = 2 arctan \frac{cos {θ}_{i} \sqrt{{sin}^{2} {θ}_{i} - {N}^{2}}}{{sin}^{2} {θ}_{i}}$$

The refractive index ratio is N=n_{gas}/n_{wall} and θᵢ is the incident angle. This phase delay converts a linearly polarized beam to elliptically polarized.

After passing through a polarizer or a Wollaston crystal, the reflected beam is separated into the

|v [symbol] and |h [symbol] polarization components. When the air density changes, the refractive index A_{%&′} and the associated phase difference δ also change, leading to a corresponding variation in the intensity of the |h [symbol] component. By measuring the intensity of this component (i.e., the probability |β|² of detecting |h [symbol] photons), the local flow properties near the wall can be inferred. The relationship between gas density and h-component intensity can be established through calibration measurements performed at several reference densities.

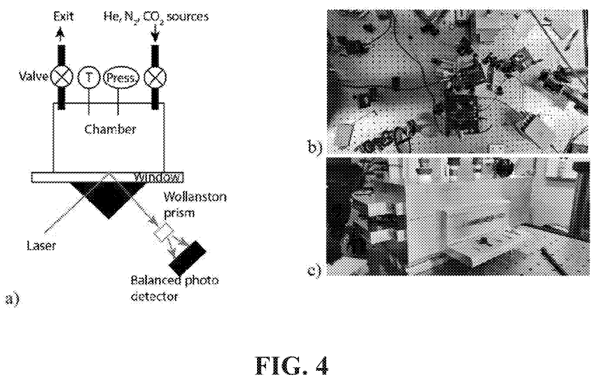

Experiment Setup and Results. The study constructed a closed test chamber to evaluate the performance of the EWDD technique. The setup consisted of a sealed container equipped with a window with prism, along with gas inlets and outlets for controlled filling and evacuation (FIG. 4). The chamber temperature and pressure were continuously monitored during testing. To vary the gas density and observe the corresponding reflection signals, the chamber was filled with helium, nitrogen, and carbon dioxide, whose densities at room temperature and 1 atm are 0.18 kg/m³, 1.25 kg/m³, and 1.98 kg/m³, respectively. Because the h-component signal was too weak to detect with conventional sensors, a balanced photodetector with a gain of 10⁷ was used to measure the intensity difference between the h′ and v′ polarization components, which are slightly rotated relative to the h and v directions.

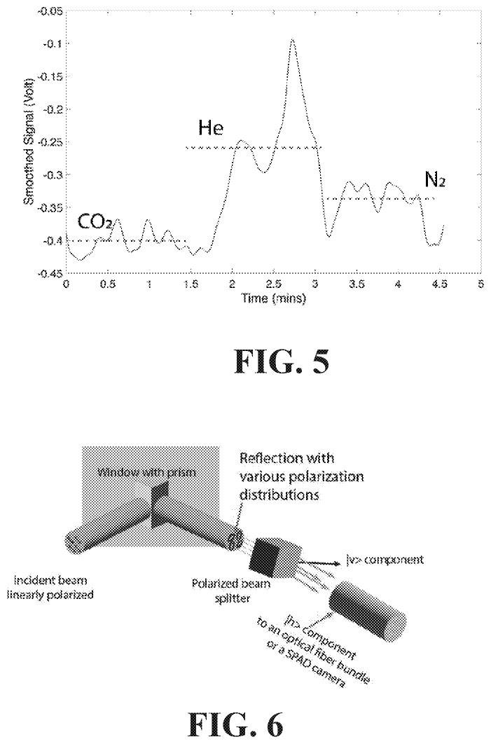

FIG. 5 shows the measurement results. The test began with CO₂ in the chamber (0-1 minute). Helium was introduced between 1 and 2.5 minutes. Nitrogen was then added from 2.5 to 4.5 minutes. The mean values of signals for each kind of gas are indicated using dashed lines. The helium signal appears well above the CO₂ line due to helium's much lower density, while the nitrogen signal lies between the helium and CO₂ traces, consistent with its intermediate density. The signal began to change approximately 0.5 minutes after each gas switch because filling the chamber required some time. In addition, the raw measurements exhibited noticeable fluctuations caused by mechanical vibration (caused by switching the gas), laser power variations, and electronic noise. For clarity, the signals presented here have been filtered.

Discussion. The results clearly show that the EWDD system responds to density changes caused by different gases. With a signal resolution of approximately 0.01 Volt, the system can resolve density differences on the order of 0.1 kg/m³ (0.01 kg/m³) on average. In other words, the EWDD is capable of measuring density with good sensitivity. The remaining fluctuations are primarily attributable to mechanical vibrations, electronic noise, and outside air flow disturbances. As discussed below, these issues can be mitigated or significantly reduced using quantum sensing techniques.

### Example 2: Development of 2D Evanescent Wave Density Detector

As discussed above, the EWDD system was demonstrated to measure density at a single spatial point. The present example extends this capability to obtain a two-dimensional density distribution, effectively developing a surface density camera for wall-bounded flows. This is accomplished by illuminating a two-dimensional region and analyzing the resulting polarization field, as illustrated in FIG. 6. Unlike the single-point EWDD setup, this system employs a polarized beam splitter to filter out the |v [symbol] -polarized photons, allowing only the |h [symbol] -polarized component to reach the detector. This design eliminates the need to compare the intensities of two polarization states in the above test, which is difficult to implement with cameras because matching images from two sensors introduces large calibration and pixel-level noise errors. It is worth noting that the |h [symbol] -component can be extremely weak, which can be remedied with the use of a single-photon detection. The described study uses a single-photon avalanche diode (SPAD) camera.

Another challenge is mapping image pixels to their corresponding physical locations in space. To achieve this, the field of view can be calibrated using surface markers, allowing each pixel to be associated with a precise physical coordinate. For a flat wall, this mapping is straightforward. However, for a curved surface, a high-order polynomial calibration can be employed to accurately account for geometric distortions.

Risk Mitigation. Mechanical vibrations contributed significant uncertainty in the preliminary single-point EWDD measurements described above. In the present example, this issue are greatly reduced in the 2D configuration. Small motions of the wall surface or prism can easily cause the reflected beam to miss a single photodetector, but a 2D camera can still capture the entire beam footprint on the sensor array. As noted above, surface markers can be used to determine the spatial location corresponding to each pixel, enabling accurate correction of residual motion. The remaining uncertainty may be quantified as part of the experimental evaluation. If wall or prism vibration proves too large to compensate through calibration, an optical fiber bundle fixed directly to the wall surface can be used to collect the reflected signal (FIG. 6), ensuring stable detection even under significant mechanical disturbances.

Thermal expansion may introduce potential errors into the measurements, and thus this effect should be carefully assessed and mitigated. Thermal expansion primarily alters the optical path length. For example, a 10° C. temperature change near the surface can cause a 500 μm glass layer to expand or contract by approximately 0.01λ (where λ is the laser wavelength, typically 500-650 nm). This corresponds to a phase shift of about 0.01, much larger than the phase difference between the parallel (∥) and perpendicular (⊥) components. However, thermal expansion does not affect the density measurement because both polarization components travel along the same optical path, and the resulting phase change cancels out. In other words, thermal expansion does not alter the polarization behavior in total internal reflection. Interestingly, the large phase shift induced by expansion can instead be used to infer surface temperature distributions, though this signal is limited to low-frequency variations due to the slow nature of heat conduction. Therefore, in the described work, thermal expansion effects are not used for temperature measurement.

Although thermal expansion does not directly affect density measurements, temperature fluctuations can introduce uncertainty by altering the refractive index of the glass wall, since n_{wall} depends on the glass density. To minimize this effect, temperature-insensitive optical materials such as N-FK5 glass can be used for the wall interface. In addition, because heat conduction in the glass occurs much more slowly than the timescale of gas density fluctuations, a high-pass filter can be applied to remove low-frequency noise associated with temperature drift. The optimal filter parameters are determined empirically based on the characteristics of the measured data.

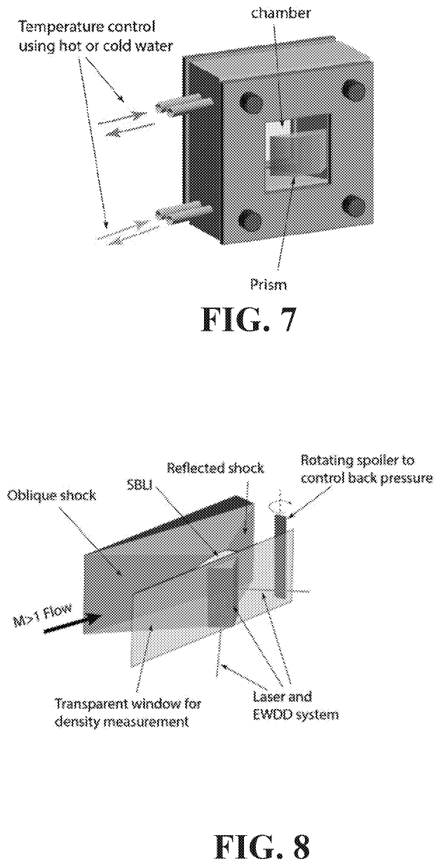

The first step is to develop the 2D density camera and calibrate it under steady and quasi-steady conditions. The steady-state calibration are performed in the test chamber shown in FIG. 7, which is a high-pressure container. The maximum pressure for the chamber is up to 90 atm. The gas density within the chamber is precisely controlled by adjusting pressure, temperature, and gas species. The designed density variation is in the range of 0-150 kg/m³, which is from vacuum to supercritical CO₂. At a fixed pressure, for example 1 atm, a fine control of density can be made by mixing N₂ and CO₂ with a 0.5% mixing ratio accuracy (corresponding density range is 1.23-1.98 kg/m³), allowing fine, repeatable variation of the test density.

A laser beam illuminates a 2×2 cm region on the wall. As described above and FIG. 6, the reflected light is separated into v and h polarized components (|v [symbol] and |h [symbol] ) using a Wollaston prism, and the weak |h [symbol] component—containing the density information—is recorded by a SPAD camera, which is capable of detecting and counting individual photons. The acquired data is used to establish a quantitative relationship between photon polarization and local fluid density, resulting in a calibration map that relates the |h [symbol] photon count (or light intensity) to the corresponding density value.

For the quasi-steady tests, the gas density is gradually varied in the high-pressure chamber by adjusting the temperature. For example, under supercritical conditions (pressure above 7 MPa), the density of CO₂ changes significantly (from approximately 300 kg/m³ to 600 kg/m³) as the temperature changes from 30° C. to 40° C. By independently controlling the temperatures at the top and bottom of the chamber, a stable temperature gradient is established and, consequently, a corresponding density gradient. The 2D density camera can capture this distribution.

Subsequently, the chamber pressure is gradually reduced to decrease the magnitude of density fluctuations and further evaluate the camera's sensitivity and accuracy. Due to the high sensitivity of the SPAD camera, the resolution is sufficient to detect density variations as small as 0.05 kg/m³ or better. In addition, by reversing the temperature gradient across the chamber, a Rayleigh-Benard convection flow is generated to further assess the performance of the density camera under dynamic conditions. In sum, a calibration function relating fluid density to light intensity is established, as well as the spatial mapping between image pixels and physical coordinates—thereby assessing the performance of the 2D EWDD system, including its measurement resolution, accuracy, and overall reliability.

2D SBLI dynamics. The 2D EWDD system is then applied to investigate the SBLIs. Because 2D SBLIs have been extensively characterized in previous experimental and computational studies, these well-documented results serve as benchmarks for validating and refining the present system under highly unsteady flow conditions.

The experimental setup is illustrated in FIG. 8. A supersonic flow enters a 2D channel. The Mach number is set at M=1.1-1.5. The inclined wall generates an oblique shock wave that reflects from a transparent window. The 2D EWDD system is mounted at this location to monitor the SBLI. The field of view is designed to cover an area of approximately 2×2 cm. The SPAD camera can record the reflected laser signal (after polarized beam splitter) at up to 10,000 frames per second, providing sufficient temporal resolution to capture the unsteady features of the 2D SBLI. To cross-validate the EWDD results, a Schlieren imaging system is simultaneously used to visualize the shock motion as a complementary diagnostic. Note that flow unsteadiness may induce mechanical vibrations that perturb the laser alignment and compromise measurement accuracy. To mitigate this issue, an optical fiber bundle may be used to collect the reflected signal and transmit it to the camera located outside the flow field, thereby isolating the sensitive optics and detection hardware from vibration effects.

Moreover, the unsteadiness in 2D SBLI can be chaotic. It is possible to control the shock oscillation by controlling the back pressure. As shown in FIG. 8, a “spoiler” is installed near the downstream end of the channel (after the shock train). The spoiler can rotate at a prescribed speed to vary the effective blockage and thus modulate the overall pressure drop in the channel. This forcing may induce oscillations in the upstream shock system. Using the EWDD system, the boundary layer may be examined to study how it responds to these moving shocks and characterize the resulting coupled unsteady behavior.

The 2D EWDD technique can be used to capture the unsteady motion of the shock and the associated boundary-layer structures. By comparing these measurements with results reported in the literature and with our cross-validated Schlieren data, the accuracy and reliability of the 2D EWDD system can be evaluated in high-speed flow environments. The system's temporal and spatial resolution are established in high-speed flows, sensitivity to density fluctuations are quantified, and key noise sources present in a wind-tunnel environment are identified. The experiments further assess the robustness of EWDD under realistic aerodynamic disturbances such as vibration, shock reflections, and optical jitter. The measurements with the spoiler can further reveal previously unresolved flow features, providing a high-quality dataset that guide and support the subsequent 3D SBLI studies.

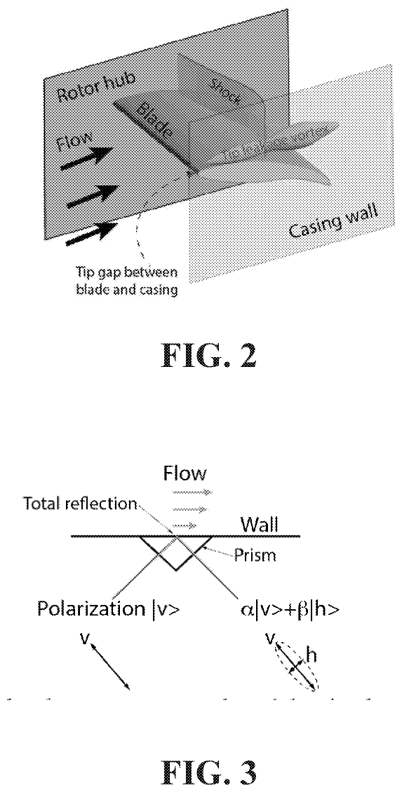

3D Shock, vortex, and boundary layer interaction. Little is known about 3D SBLIs in general, and even less about interactions involving additional dominant structures such as vortices. Thus, the example sought to study these coupled interactions because, in complex environments like a compressor, boundary-layer instabilities can strongly influence the overall flow behavior. The specific flow of interest is the interaction between a tip-leakage vortex (TLV) and a shock wave. To prevent rotor-casing contact in a compressor, a small clearance (i.e., the tip gap) is maintained between the blade tip and the casing. The pressure difference between the pressure and suction sides of the blade drives a tip-leakage flow that rolls up into the TLV (FIG. 2). Although its formation mechanism is similar to that of a wingtip vortex, the TLV is confined by the casing and evolves in a much more restricted environment. At low speeds, the tip-leakage flow and TLV are known to trigger stall or surge under adverse operating conditions. However, their behavior and interaction with shocks in transonic or supersonic regimes remain largely unexplored.

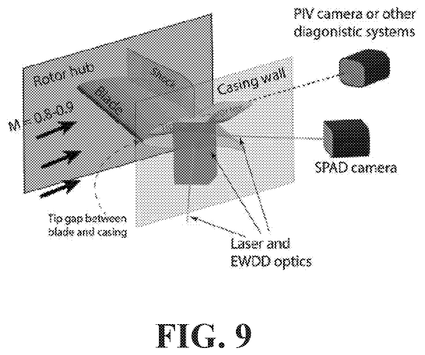

To simplify the problem, the study uses a stationary blade and casing configuration (FIG. 9). A transonic inlet flow generates a shock on the blade's suction side, which interacts with the TLV. The density camera system measures near-wall density variations to capture the dynamics of both the TLV and the shock wave. Simultaneously, flow-visualization techniques and particle-based velocimetry are used to obtain the velocity field within the passage. The study further varies the blade angle of attack to mimic the changing flow conditions that occur in a rotor operating near stall.

Conclusion. The development of 2D EWDD opens an avenue to measure density in high-speed flows and exhibits several advantages over conventional techniques. The EWD system and method are multipurpose, easy to implement, and non-intrusive. Unlike PSP material that reacts with O₂, the EWD can be used for all kinds of gas. This is crucial for reacting flow diagnosis. More importantly, it is appliable in harsh environments with high temperature and corrosion gas because it does not place any vulnerable sensor in the flow. It provides a wide measurable range of density (e.g., a density variation from 0 to 10 atm only cause 10⁻³ phase shift). It provides previously unknown information about SBLI, especially 3D interactions in a complex environment. The entire EWD system can be developed to a portable module. Consequently, it can be installed inside a high-Mach projectile to monitor the boundary layer and provide information for active flow control.

The following patents, applications and publications as listed below and throughout this document are hereby incorporated by reference in their entirety herein.
[1] Settles, G. S., and Hargather, M. J., 2017, “A Review of Recent Developments in Schlieren and Shadowgraph Techniques,” Meas Sci Technol, 28(4), p. 042001.
[2] Bar-Ziv, E., Sgulim, S., and Keren, E., 1983, “Temperature Mapping in Flames by Moiré Deflectometry,” Appl Opt, 22(5), pp. 698-705.
[3] Stricker, J., and Kafri, O., 1982, “A New Method for Density Gradient Measurements in Compressible Flows,” AIAA Journal, 20(6), pp. 820-823.
[4] Chuan-sen, D., Yun-yun, C., Fen-ping, C., and tao, L., 2019, “Discussion of Species Composition for Flow Field's Temperature Reconstruction by Opticaltomography,” Optik (Stuttg), 185, pp. 1277-1283.
[5] Mielke, A., Elam, K., and Sung, C.-J., 2006, “Rayleigh Scattering Diagnostic for Measurement of Temperature, Velocity, and Density Fluctuation Spectra,” 44th AIAA Aerospace Sciences Meeting and Exhibit, American Institute of Aeronautics and Astronautics, Reston, Virigina.
[6] Gregory, J. W., Sakaue, H., Liu, T., and Sullivan, J. P., 2014, “Fast Pressure-Sensitive Paint for Flow and Acoustic Diagnostics,” Annu Rev Fluid Mech, 46(1), pp. 303-330.
[7] Gregory, J. W., Asai, K., Kameda, M., Liu, T., and Sullivan, J. P., 2008, “A Review of Pressure-Sensitive Paint for High-Speed and Unsteady Aerodynamics,” Proc Inst Mech Eng G J Aerosp Eng, 222(2), pp. 249-290.
[8] Jiang, N., Hsu, P. S., Gragston, M., and Roy, S., 2023, “Recent Progress in High-Speed Laser Diagnostics for Hypersonic Flows [Invited],” Appl Opt, 62(6), p. A59.
[9] Slipchenko, M. N., Meyer, T. R., and Roy, S., 2021, “Advances in Burst-Mode Laser Diagnostics for Reacting and Nonreacting Flows,” Proceedings of the Combustion Institute, 38(1), pp. 1533-1560.
[10] Abbott, B. P., Abbott, R., Abbott, T. D., et al., 2016, “Observation of Gravitational Waves from a Binary Black Hole Merger,” Phys Rev Lett, 116(6), p. 061102.
[11] Lawson, J. M., Neet, M. C., Grossman, I. J., and Austin, J. M., 2020, “Static and Dynamic Characterization of a Focused Laser Differential Interferometer,” Exp Fluids, 61(8), p. 187.
[12]W. M. Tolles, J. W. Nibler, J. R. McDonald, and A. B. Harvey, 1977, “A Review of the Theory and Application of Coherent Anti-Stokes Raman Spectroscopy (CARS),” Appl Spectrosc, 31, pp. 253-271.
[13] Born, M., and Emil Wolf, 2013, Principles of Optics: Electromagnetic Theory of Propagation, Interference and Diffraction of Light, Elsevier.

What is claimed is:

1. A method for characterizing near-wall properties of a compressible fluid, the method comprising:
irradiating an internal reflection element (IRE) with a linearly polarized incident light signal, wherein the IRE is positioned relative to a wall to form a refractive boundary together with a fluid along the wall, wherein the linearly polarized incident light signal undergoes total internal reflection (TIR) within the IRE at the refractive boundary to form a reflected light signal;
splitting the reflected light signal using an optical polarizer to form a first polarized component and a second polarized component of the reflected light signal, wherein the first polarized component and the second polarized component have orthogonal polarizations,
detecting via a balanced photodetector the first and/or second polarized components of the reflected light signal; and
determining one or more fluid characteristics from the first and/or second polarized components of the reflected light signal.

2. The method of claim 1, wherein the one or more fluid characteristic comprises fluid density.

3. The method of claim 1, further comprising: outputting a report comprising qualitative/quantitative information about the one or more fluid characteristics.

4. The method of claim 3, wherein the report comprises a two-dimensional map depicting a spatial representation of the one or more fluid characteristics over an 2D area of the wall.

5. The method of claim 1, wherein the one or more fluid characteristics is determined in real-time.

6. The method of claim 5, further comprising: adjusting a system parameter based on the determined one or more fluid characteristics.

7. The method of claim 1, wherein the fluid is a gas.

8. The method of claim 1, wherein the fluid is flowing at a transonic or supersonic velocity along the wall.

9. The method of claim 1, wherein the linearly polarized incident light signal comprises an array of incident light signals over a 2D area along the wall, and wherein the reflected light signal comprises an array of reflected light signals corresponding to phase shifted signals following TIR of the array of incident light signals.

10. The method of claim 9, wherein the wall comprises one or more surface markers, and wherein one or more surface markers are used to index a spatial location of a pixel in the 2D area.

11. The method of claim 1, further comprising interrogating the reflected light signal using an optical fiber fixedly or detachably coupled to the IRE.

12. The method of claim 1, wherein the one or more fluid characteristics is determined by comparing an intensity of the first and/or second polarization components to a calibration curve.

13. A system comprising:
a sensing component comprising:
a light source configured to provide a linearly polarized incident light signal to an internal reflection element (IRE), the IRE configured to be positioned relative to a wall to form a refractive boundary with a fluid along the wall such that a reflected light signal is formed when the linearly polarized incident light signal undergoes total internal reflection (TIR) within the IRE at the refractive boundary,
an optical polarizer arranged wherein the optical polarizer is configured to split the reflected light signal to form a first polarized component and a second polarized component of the reflected light signal, wherein the first polarized component and the second polarized component have different polarizations, and
a photodetector positioned to detect the first and/or second polarized components of the reflected light signal; and
a processor, and memory operatively coupled to the processor and having instructions stored thereon, wherein execution of the instructions by the processor causes the processor to:
obtain data from the photodetector corresponding to an intensity of the first and/or second polarized components of the reflected light signal, and
determine one or more fluid characteristics from the data.

14. The system of claim 13, wherein the light source is configured to provide an array of incident light signals over a 2D area.

15. The system of claim 13, wherein the processor is further configured to generate a report comprising qualitative/quantitative information about the one or more fluid characteristics.

16. The system of claim 15, wherein the report comprises a two-dimensional map depicting a spatial representation of the one or more fluid characteristics over an area of the wall.

17. The system of claim 13, wherein the processor is further configured to adjust a process parameter based on the determined one or more fluid characteristics.

18. The system of claim 13, wherein the photodetector comprises a single-photon detector.

19. The system of claim 13, further comprising an optical fiber bundle fixedly or detachably coupled to the IRE to interrogate the reflected light signal and to transmit the reflected light signal to the optical polarizer and/or the photodetector.

20. The system of claim 13, wherein the processor is further configured to determine the one or more fluid characteristics by comparing an intensity of the first and/or second polarization components to a calibration curve.
